(19) United States
(12) Patent Application Publication
(10) Pub. No.: US 2008/0271711 A1
(43) Pub. Date: Nov. 6, 2008

(54) Four-Stroke Free Piston Engine

(76) Inventor: Peter Charles Cheeseman, San Francisco, CA (US)

Correspondence Address: PATENT LAW GROUP LLP, 2635 NORTH FIRST STREET, SUITE 223, SAN JOSE, CA, 95134, US

(21) Appl. No.: 12/094,266

(22) PCT Filed: Nov. 21, 2006
(86) PCT No.: PCT/AU2006/001753

§ 371 Date: May 19, 2008

(30) Foreign Application Priority Data
Nov. 22, 2005 (AU) 2005906492

(51) Int. Cl. F02B 71/00

(52) U.S. Cl. 123/46 E

(57) ABSTRACT

A free piston engine utilizes a shuttle frame external to combustion chambers to rigidly link shuttle parts reciprocating along a centerline. If the shuttle parts are spaced apart along the centerline, the shuttle frame may be struts extending from the shuttle parts and linked by rods. Alternatively the shuttle parts are within a tubular shuttle frame that forms part of the combustion chamber boundary. If one shuttle part is arranged around the other with both centered about the centerline, the shuttle frame may include an annular plate between a cylindrical inner shuttle part and an annular outer shuttle part. Alternatively the shuttle frame may include an inner tube with a cylindrical inner shuttle part within the inner tube, and an outer tube with an annular outer shuttle part arranged between the inner and the outer tubes so that the shuttle frame forms part of the combustion chamber boundary.

### FIELD OF INVENTION

The present invention relates to free piston engines and more specifically to a four-stroke free piston engine.

### BACKGROUND OF THE INVENTION

Otto cycle four-stroke internal combustion engines have been in use for over a century, and are still widespread. This is mainly because of their relatively high efficiency and high power-to-weight ratio.

However, standard crank operated, spark ignition (SI), four-stroke, internal combustion engines, such as those found commonly in cars, are limited to a compression ratio of roughly 10:1, because of “knocking” at higher compression ratios. This limited compression ratio fundamentally limits the efficiency of an SI engine.

A diesel engine, on the other hand, is not subject to knocking because the fuel is not injected until near maximum compression is achieved. As a result, diesel engines can achieve a higher compression ratio than SI engines, and therefore higher efficiency. Unfortunately, the non-uniform mixing of fuel and air during fuel injection in a diesel engine typically creates particulate emissions (“soot”) as well as polluting gases, and this pollution is generally unacceptable, despite the higher efficiency.

Both conventional SI and diesel engines transform the linear motion of the piston(s) into rotational motion of a shaft by operation of a crank. The crank in a crank engine transmits a significant fraction of piston force to the cylinder walls and the crank bearing. At top dead center (TDC), when the expansion force is at a maximum, practically all the expansion force is transmitted to the crank bearing instead of accelerating the piston. This leads to wear on the bearing. It also means that the piston spends a significant fraction of its cycle near TDC and so loses a significant amount of heat to the chamber walls, thus decreasing efficiency.

A free piston engine, on the other hand, is able to transform the piston's linear reciprocating motion directly into other forms of energy, such as electrical, pneumatic or hydraulic energy, without first converting it into rotational energy. A free piston engine has a number of advantages over crank engines. In particular, in free piston engines all the force of the expanding gases typically acts in the direction of motion, without significant side force acting to push the piston against the cylinder walls. Further, proportionately less of the cycle is near TDC for a free piston, compared to a crank engine piston, resulting in less heat loss and greater efficiency.

Another advantage of free piston engines over crank engines is that they can easily take advantage of an approach commonly referred to as homogeneous charge compression ignition (HCCI). In HCCI, the piston compresses a pre-mixed, lean fuel air mixture adiabatically until the increasing temperature ignites the mixture. HCCI avoids particulate emissions because the fuel and air are fully mixed before ignition. HCCI avoids knocking primarily by using a lean fuel to air ratio, which is below the flammability limit. Like diesel ignition, HCCI relies on the high temperature created by compression to ignite the fuel air mixture (charge). Because of the HCCI lean charge, the combustion temperature is relatively low, and so nitrous oxides and other polluting gases are reduced compared to SI engines, and the compression ratio is much higher, giving higher efficiency, comparable to diesel engines. However, the practical difficulty of timing HCCI in synchrony with the piston at TDC in a crank engine has deterred the use of HCCI in crank operated internal combustion engines.

Free piston internal combustion engines are generally two-stroke engines. Two stroke engines suffer from the problem that there is inevitably some mixing of the fresh charge with the exhaust gas stream. This not only leads to lower efficiency, but generally produces unacceptable levels of pollution. Accordingly, two-stroke engines are not widely used, except in small-scale applications where the level of pollution is not serious. A four-stroke free piston engine has been proposed in U.S. Pat. No. 6,582,204 (Gray, Jr.). This involves the coupling of two free-piston assemblies through a rack-and-pinion arrangement so that they oscillate in opposite directions. The rack and pinion coupling allows one piston assembly to alternately drive the other. This method of coupling has significant disadvantages. Firstly, the pinions exert a strong side load on both pistons, because they necessarily act on the pistons' sides, rather than along the pistons' axes. This side-loading detracts from a major advantage of free piston engines, which ideally have no side loading. The main problems caused by side loading are increased wear and difficulties of lubricating under high load. Another disadvantage of the rack and pinion coupling is the wear and friction on both the rack and the pinion, as all the force on the piston must be transmitted through this coupling. Other couplings proposed in Gray, Jr. include hydromechanical flexible linkages, with chains, check valves, extra pistons and the like. Such complex couplings reduce the efficiency of the engine.

### OBJECT OF THE INVENTION

It is the object of the present invention to substantially overcome or at least ameliorate one or more of the above disadvantages.

### SUMMARY OF INVENTION

In accordance with the invention, a four-stroke free piston internal combustion engine utilizes a shuttle frame located external to combustion chambers to rigidly link the reciprocating movements of shuttle parts along a shuttle centerline. The shuttle frame replaces the conventional internal connecting rod located within the combustion chambers, thereby improving access for lubricating and cooling the shuttle parts without adding any side loading to the shuttle parts.

In some embodiments, the shuttle parts are spaced apart along the shuttle centerline. In one embodiment, the shuttle frame includes radial struts that extend from the shuttle parts and are joined by rods running parallel to the shuttle centerline. In another embodiment, the shuttle frame is tubular and the shuttle parts are fixed within the shuttle frame. The engine block has an inner block located in the shuttle frame between the shuttle parts, and outer blocks inserted into the ends of the shuttle frame. Each combustion chamber is bounded by the shuttle frame, one piston end, and the corresponding block.

In some embodiments, one shuttle part is arranged around the other shuttle part with both centered about the shuttle centerline. In one embodiment, the shuttle frame includes an annular plate between a cylindrical inner shuttle part and an annular outer shuttle part around the inner shuttle part. In another embodiment, the shuttle frame includes an inner tubular wall with a cylindrical inner shuttle part fixed within the inner tubular wall, and an outer tubular wall with an annular outer shuttle part arranged between the inner and the outer tubular walls. The engine block has cylindrical inner blocks inserted into the ends of the inner tubular wall, and outer annular blocks inserted into the space defined between the inner and the outer tubular walls. Each combustion chamber is bounded by the shuttle frame, one piston end, and the corresponding block.

### BRIEF DESCRIPTION OF DRAWINGS

Preferred forms of the present invention will now be described by way of example with reference to the accompanying drawings, wherein similar reference numbers denote similar features and wherein:

FIGS. 1A to 1D are cross sectional views of each stroke of an example four-stroke free piston engine;

FIG. 2A is a cross-sectional view of a first embodiment of a free piston engine;

FIG. 2B is a cross-sectional view along line A-A of FIG. 2A;

FIG. 2C is a cross-sectional view along line B-B of FIG. 2A;

FIG. 3A is a cross-sectional view of a second embodiment of a free piston engine;

FIG. 3B is a cross-sectional view along line A-A of FIG. 3A;

FIG. 4A is a cross-sectional view of a third embodiment of a free piston engine;

FIG. 4B is a cross-sectional view along line A-A of FIG. 4A;

FIG. 4C is a top view of the embodiment depicted in FIG. 4A;

FIG. 4D is a cross-sectional view along the line B-B of FIG. 4C;

FIG. 5A is a cross-sectional view of a fourth embodiment of a free piston engine;

FIG. 5B is a cross-sectional view along line A-A of FIG. 5A;

FIG. 6A is a cross-sectional view of a fifth embodiment of a free piston engine;

FIG. 6B is a cross-sectional view along line A-A of FIG. 6A;

FIG. 7A is a cross-sectional view of a sixth embodiment of a free piston engine;

FIG. 7B is a cross-sectional view along line A-A of FIG. 7A;

FIG. 8A is a cross-sectional view of an alternative form of the embodiment of FIG. 2A;

FIG. 8B is a further cross-sectional view of the engine of FIG. 8A; and

FIG. 9 is a schematic diagram of the embodiment of FIG. 2A with a feedback controller.

### DETAILED DESCRIPTION

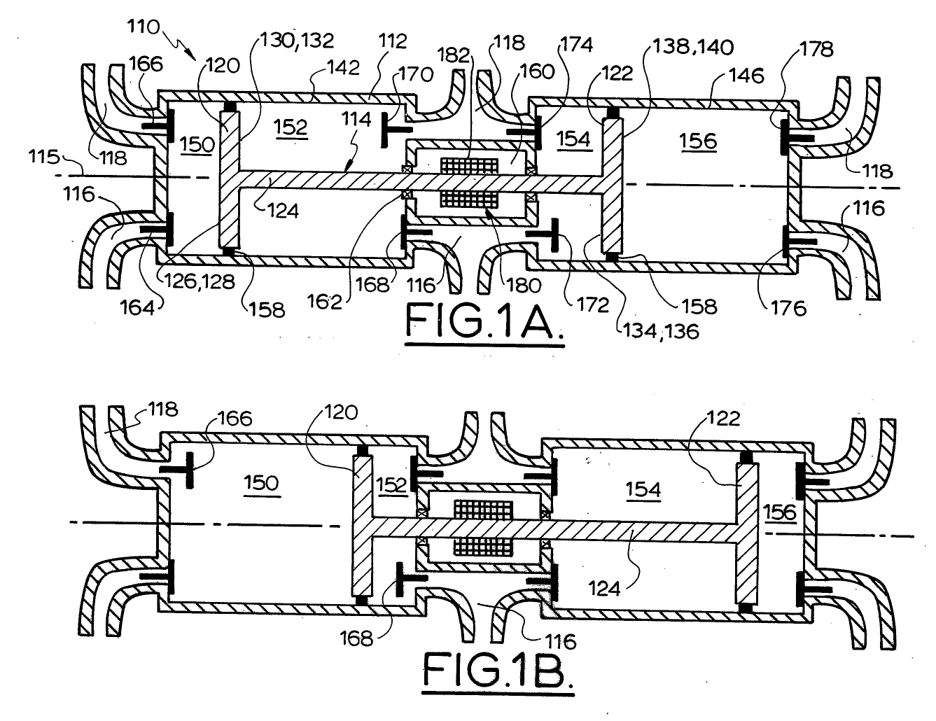

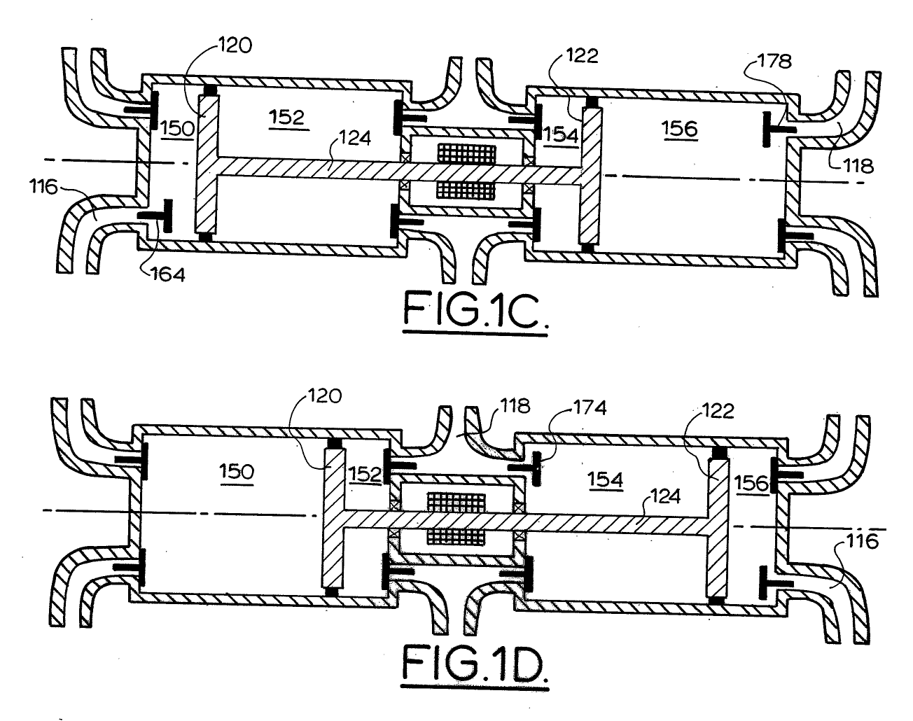

Referring to the drawings, FIGS. 1A through 1D depict an example of a four-stroke free piston internal combustion engine 110 for the purpose of demonstrating the four stroke cycle. The engine 110 comprises an engine block structure 112 and a shuttle 114 mounted to the engine block structure 112 for reciprocal movement relative thereto along a shuttle centerline 115. The engine 110 further comprises a selectively sealable network of inlet passages 116, which communicate with a fuel/air supply (not shown), and a selectively sealable network of outlet passages 118, which communicate with an exhaust system (not shown).

The free piston shuttle 114 comprises a first generally cylindrical shuttle part 120, a second generally cylindrical shuttle part 122 axially spaced from the first shuttle part 120 and a connecting rod 124 connecting the first and second shuttle parts 120, 122. The first and second shuttle parts 120, 122 are axially aligned along the shuttle centerline 115. The first shuttle part 120 has a first piston end 126, providing a generally circular first shuttle surface 128, and a second piston end 130, providing a generally circular second shuttle surface 132. The second shuttle part 122 has a third piston end 134, providing a generally circular third shuttle surface 136, and a fourth piston end 138, providing a generally circular fourth shuttle surface 140.

The engine block structure 112 includes a generally cylindrical first cavity 142, in which the first shuttle part 120 is mounted, and a generally cylindrical second cavity 146, in which the second shuttle part 122 is mounted. This arrangement defines four generally cylindrical chambers: a first chamber 150 bounded by the first cavity 142 and the first shuttle surface 128; a second chamber 152 bounded by the first cavity 142 and the second shuttle surface 132; a third chamber 154 bounded by the second cavity 146 and the third shuttle surface 136; and a fourth chamber 156 bounded by the second cavity 146 and the fourth shuttle surface 140. Low friction chamber seals 158, such as piston rings, mounted on each of the shuttle parts 120, 122 ensure the fluid isolation of each of the chambers 150, 152, 154, 156. The connecting rod 124 extends between the first cavity 142 and the second cavity 146 via a bore 160 in the engine block structure 112 penetrating the second and third chambers 152, 154. The connecting rod 124 also reduces the surface area of the second and third shuttle surfaces 132, 136. Bore seals 162 between the connecting rod 124 and the bore 160 isolate the second and third chambers 152, 154 from one another.

The first chamber 150 communicates with the network of inlet passages 116, via a first inlet valve 164, and with the network of outlet passages 118, via a first outlet valve 166. Similarly, the second chamber 152 communicates with the network of inlet passages 116, via a second inlet valve 168, and with the network of outlet passages 118, via a second outlet valve 170. The third chamber 154 communicates with the network of inlet passages 116, via a third inlet valve 172, and with the network of outlet passages 118, via a third outlet valve 174. Similarly, the fourth chamber 156 communicates with the network of inlet passages 116, via a fourth inlet valve 176, and with the network of outlet passages 118, via a fourth outlet valve 178.

A power extraction device 180 is mounted to the engine block structure 112 between the first cavity 142 and the second cavity 146 and surrounds a portion of the connecting rod 124. The power extraction device 180 is depicted here in the form of an electromagnetic induction device, comprising magnets (not shown) provided on the connecting rod 124 and induction coils 182 provided in the engine block structure 112 around the connecting rod 124. The power extraction device 180 can be reversible, meaning that in addition to extracting power from the shuttle 114, it can also supply power to the shuttle 114. This is useful during start up.

In operation, to start the engine 110, a fuel/air mixture is supplied to the first chamber 150, the electromagnetic induction device is powered in reverse and drives the shuttle 114 to the position shown in FIG. 1A, compressing the fuel/air mixture in the first chamber 150, which is then ignited by, for example, SI or HCCI. This results in the configuration shown in FIG. 1A, which depicts a “first stroke”. The ignited fuel/air mixture in the first chamber 150 combusts and drives the first shuttle part 120 from left to right. Gases within the second chamber 152 are driven out via the open second outlet valve 170. The second shuttle part 122, being fixed relative to the first shuttle part 120, is driven from left to right by the first shuttle part 120. This draws a fuel/air mixture into the third chamber 154 via the third inlet valve 172 and compresses a fuel/air mixture in the fourth chamber 156. At the completion of this stroke, the second outlet valve 170 and the third inlet valve 172 are closed and the first outlet valve 166 and the second inlet valve 168 are opened. These events result in the configuration shown in FIG. 1B.

Referring to FIG. 1B, which depicts a “second stroke”, the compressed fuel/air mixture in the fourth chamber 156 combusts and drives the second shuttle part 122 from right to left, compressing the fuel/air mixture within the third chamber 154. The first shuttle part 120, being fixed relative to the second shuttle part 122, is driven by the second shuttle part 122 from right to left. This expels combustion products from the first chamber 150 via the open first outlet valve 166 and draws a fuel/air mixture into the second chamber 152 via the open second inlet valve 168. At the completion of this stroke, the first outlet valve 166 and the second inlet valve 168 are closed and the fourth outlet valve 178 and the first inlet valve 164 are opened. These events result in the configuration shown in FIG. 1C.

Referring to FIG. 1C, which depicts a “third stroke”, the compressed fuel/air mixture in the third chamber 154 combusts and drives the second shuttle part 122 from left to right, expelling the combustion products from the fourth chamber 154 via the open fourth outlet valve 178. The first shuttle part 120, being fixed relative to the second shuttle part 122, is driven by the second shuttle part 122 from left to right. This compresses the fuel/air mixture in the second chamber 152 and draws a fuel/air mixture into the first chamber 150 via the open first inlet valve 164. At the completion of this stroke, the fourth outlet valve 178 and the first inlet valve 164 are closed and the third outlet valve 174 and the fourth inlet valve 176 are opened. These events result in the configuration shown in FIG. 1D.

Referring to FIG. 1D, which depicts a “fourth stroke”, the compressed fuel/air mixture in the second chamber 152 combusts and drives the first shuttle part 120 from right to left, compressing the fuel/air mixture in the first chamber 150. The second shuttle part 122, being fixed relative to the first shuttle part 120, is driven by the first shuttle part 120 from right to left. This expels combustion products from the third chamber 154 via the open third outlet valve 174 and draws a fuel/air mixture into the fourth chamber 156 via the fourth inlet valve 176. At the completion of this stroke, the third outlet valve 174 and the fourth inlet valve 176 are closed and the second outlet valve 170 and the third inlet valve 172 are opened. These events result in the configuration shown in FIG. 1A and the cycle commences again.

In this way, the shuttle 114 reciprocates back and forth within the engine block structure 112. The reciprocating motion of the magnets (not shown) on the connecting rod 124 induces an electric current in the induction coils 182, providing an electric power output source.

The bore seal 162 and the chamber seals 158 in contact with the walls of the cavities 142, 146 ideally provide a good, low-friction seal. Possible means for providing the necessary lubrication and seals include piston rings, gas bearings or other means well known to those skilled in the art. The absence of side-loading on the piston shuttle 114 makes the provision of a low friction seal easier than in crank engines.

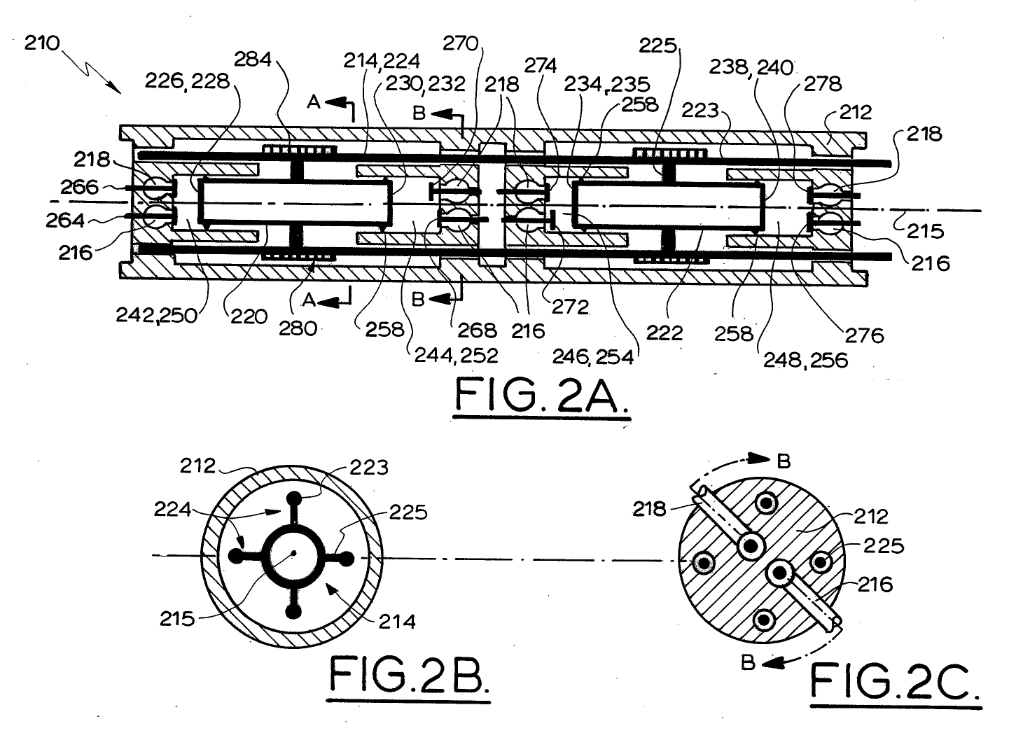

A first embodiment comprising a linear four stroke free piston internal combustion engine 210 is depicted in FIGS. 2A to 2C. The engine 210 comprises an engine block structure 212 and a rigid shuttle 214 mounted to the engine block structure 212 for reciprocal movement relative thereto along a linear shuttle centerline 215. The engine 210 further comprises a selectively sealable network of inlet passages 216, which communicate with a fuel/air supply (not shown), and a selectively sealable network of outlet passages 218, which communicate with an exhaust system (not shown).

The shuttle 214 comprises a generally cylindrical first shuttle part 220, a generally cylindrical second shuttle part 222 axially spaced from the first shuttle part 220 and a shuttle frame 224 rigidly fixing the first shuttle part 220 relative to the second shuttle part 222. Accordingly, the first and second shuttle parts 220, 222 cannot move relative to one another. The first and second shuttle parts 220, 222 are axially aligned along the shuttle centerline 215. As best shown in FIGS. 2B and 2C, the shuttle frame 224 comprises four rods 223 equally spaced from the shuttle centerline 215 and each other around the shuttle parts 220, 222. In alternative embodiments, any number of rods can be provided. The rods 223 are connected to the shuttle parts 220, 222 by struts 225. The first shuttle part 220 has a first piston end 226, providing a generally circular first shuttle surface 228, and a second piston end 230, providing a generally circular second shuttle surface 232. The second shuttle part 222 has a third piston end 234, providing a generally circular third shuttle surface 236, and a fourth piston end 238, providing a generally circular fourth shuttle surface 240.

The engine block structure 212 includes a generally cylindrical first cavity 242 housing the first piston end 226, a generally cylindrical second cavity 244 housing the second piston end 230, a generally cylindrical third cavity 246 housing the third piston end 234 and a generally cylindrical fourth cavity 248 housing the fourth piston end 238. This arrangement defines four generally cylindrical chambers: a first chamber 250 bounded by the first cavity 242 and the first shuttle surface 228; a second chamber 252 bounded by the second cavity 244 and the second shuttle surface 232; a third chamber 254 bounded by the third cavity 246 and the third shuttle surface 236; and a fourth chamber 256 bounded by the fourth cavity 248 and the fourth shuttle surface 240. Low friction chamber seals 258, mounted on each of the piston ends 226, 230, 234, 238 ensure fluid isolation of each of the chambers 250, 252, 254, 256.

In FIG. 2A, the shuttle parts 220, 222 are shown as cylinders. Since the seals 258 are the only part of the shuttle 214 in contact with the engine block structure 212, the central portion of the cylindrical shuttle parts 220, 222 between the shuttle surfaces 228, 232, 236, 240 could be replaced by any structural component that connects the shuttle surfaces 228, 232, 236, 240 to the shuttle frame 224. Such components must be designed to rigidly transmit the forces acting on the shuttle surfaces 228, 232, 236, 240 to the shuttle frame 224.

The first chamber 250 communicates with the network of inlet passages 216, via a first inlet valve 264, and with the network of outlet passages 218, via a first outlet valve 266. Similarly, the second chamber 252 communicates with the network of inlet passages 216, via a second inlet valve 268, and with the network of outlet passages 218, via a second outlet valve 270. The third chamber 254 communicates with the network of inlet passages 216, via a third inlet valve 272, and with the network of outlet passages 218, via a third outlet valve 274. Similarly, the fourth chamber 256 communicates with the network of inlet passages 216, via a fourth inlet valve 276, and with the network of outlet passages 218, via a fourth outlet valve 278.

A power extraction device 280 is provided in the engine block structure 212. The power extraction device 280 is depicted in the form of a reversible electromagnetic induction device, comprising magnets 284 provided on the shuttle frame 224 and induction coils (not shown) provided in the engine block structure 212 adjacent the magnets 284.

In operation, the shuttle 214 reciprocates with the same general cycle as described in relation to the example engine 110 with reference to FIGS. 1A to 1D, with FIG. 2A corresponding to the first stroke depicted in FIG. 1A. The shuttle 214 moves along the linear shuttle centerline 215 such that the center of pressure acting on the shuttle parts 220, 222 lies on the shuttle centerline 215. This is achieved by making both the shuttle 214 and the engine block structure 212 axisymmetric and balanced about the shuttle centerline 215. Accordingly, there is no turning moment acting on the shuttle 214 and there is no side-loading between the shuttle 214 and the engine block structure 212. This lack of side-loading minimises frictional forces and corresponding wear to the seals 258.

Since the shuttle frame 224 is entirely external of the chambers 250, 252, 254, 256, the bore seals 162 and any associated lubrication of the example engine 110 are not necessary. Further, the chambers 250, 252, 254, 256 are all identical, unlike the example engine 110 in which the rod 124 compromises the second and third chambers 152, 154 and reduces the surface area of the second and third shuttle surfaces 132, 136 relative to the first and fourth shuttle surfaces 128, 140. This means that the second embodiment encounters less friction, has less components and has less possible gas leakage points. Further, since the shuttle parts 220, 222 are readily accessible from the outside, the shuttle parts 220, 222 can be easily cooled and lubricated. In contrast, it would be very difficult to deliver lubricating or cooling fluid to the shuttle parts 120, 122 of the example engine 110, without seriously compromising performance.

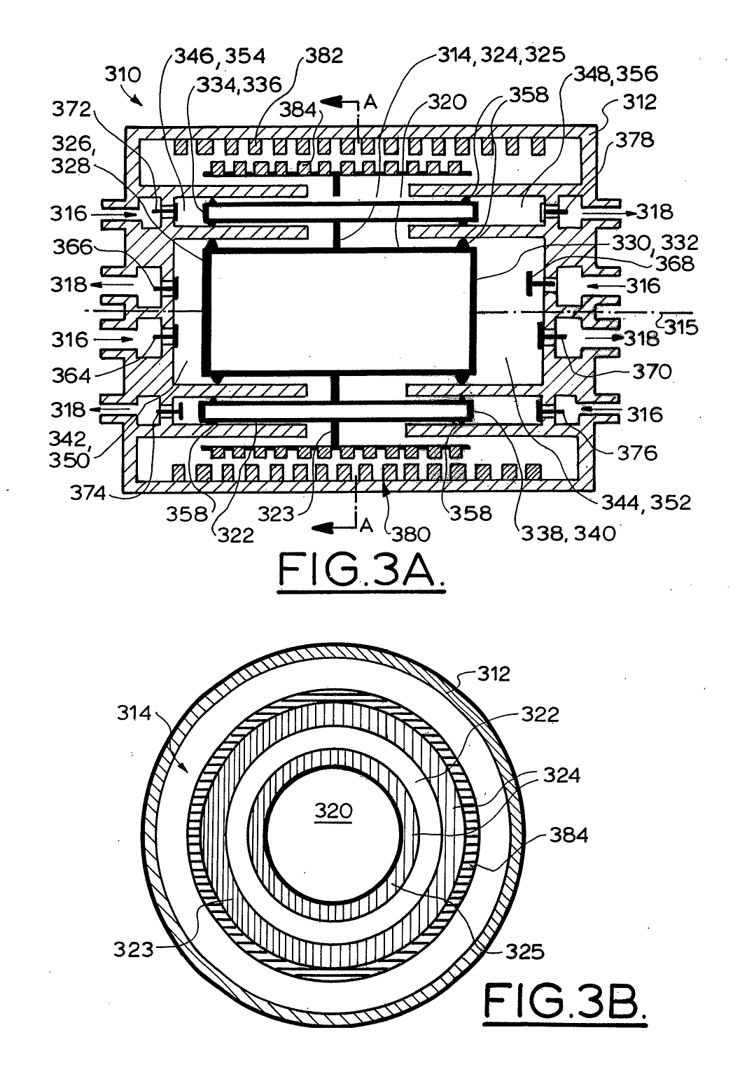

A second embodiment comprising a coaxial four stroke free piston internal combustion engine 310 is depicted in FIGS. 3A and 3B. The engine 310 comprises an engine block structure 312 and a rigid shuttle 314 mounted to the engine block structure 312 for reciprocal movement relative thereto along a linear shuttle centerline 315. The engine 310 further comprises a selectively sealable network of inlet passages 316, which communicate with a fuel/air supply (not shown), and a selectively sealable network of outlet passages 318, which communicate with an exhaust system (not shown).

As best shown in FIG. 3B, the shuttle 314 comprises a generally cylindrical first shuttle part 320, a generally annular prismatic (i.e. in the shape of an annular prism) second shuttle part 322 and a shuttle frame 324 rigidly fixing the first shuttle part 320 relative to the second shuttle part 322. In the context of this specification, the term “prism” is used to describe a geometric shape that has a uniform cross-section (such as an annulus) along its length. Accordingly, the first and second shuttle parts 320, 322 cannot move relative to one another. The second shuttle part 322 has a greater inside diameter than an outside diameter of the first shuttle part 320 and the second shuttle part 322 is coaxially arranged around the first shuttle part 320 along the shuttle centerline 315. The shuttle frame 324 comprises an annular plate 325 extending between the first and second shuttle parts 320, 322. The first shuttle part 320 has a first piston end 326, providing a generally circular first shuttle surface 328, and a second piston end 330, providing a generally circular second shuttle surface 332. The second shuttle part 322 has a third piston end 334, providing a generally annular third shuttle surface 336, and a fourth piston end 338, providing a generally annular fourth shuttle surface 340.

The engine block structure 312 includes a generally cylindrical first cavity 342 housing the first piston end 326, a generally cylindrical second cavity 344 housing the second piston end 330, a generally annular prismatic third cavity 346 housing the third piston end 334 and a generally annular prismatic fourth cavity 348 housing the fourth piston end 338. This arrangement defines two generally cylindrical chambers and two generally annular prismatic chambers: a first chamber 350 bounded by the first cavity 342 and the first shuttle surface 328; a second chamber 352 bounded by the second cavity 344 and the second shuttle surface 332; a third chamber 354 bounded by the third cavity 346 and the third shuttle surface 336; and a fourth chamber 356 bounded by the fourth cavity 348 and the fourth shuttle surface 340. Low friction chamber seals 358, mounted on each of the piston ends 326, 330, 334, 338 ensure fluid isolation of each of the chambers 350, 352, 354, 356.

The first chamber 350 communicates with the network of inlet passages 316, via a first inlet valve 364, and with the network of outlet passages 318, via a first outlet valve 366. Similarly, the second chamber 352 communicates with the network of inlet passages 316, via a second inlet valve 368, and with the network of outlet passages 318, via a second outlet valve 370. The third chamber 354 communicates with the network of inlet passages 316, via a third inlet valve 372, and with the network of outlet passages 318, via a third outlet valve 374. Similarly, the fourth chamber 356 communicates with the network of inlet passages 316, via a fourth inlet valve 376, and with the network of outlet passages 318, via a fourth outlet valve 378.

A power extraction device 380 is provided in the engine block structure 312. The power extraction device 380 is depicted in the form of a reversible electromagnetic induction device, comprising magnets 384 provided on an outer component 323 of the shuttle frame 324 and induction coils 382 provided in the engine block structure 312 adjacent the magnets 384.

In operation, the shuttle 314 reciprocates with the same general cycle as described in relation to the example engine 110 with reference to FIGS. 1A to 1D, with FIG. 3A corresponding to the first stroke depicted in FIG. 1A. The shuttle 314 moves along the linear shuttle centerline 315 such that the center of pressure acting on the shuttle parts 320, 322 lies on the shuttle centerline 315. This is achieved by making both the shuttle 314 and the engine block structure 312 axisymmetric and balanced about the shuttle centerline 315. Accordingly, there is no turning moment acting on the shuttle 314 and there is no side-loading between the shuttle 314 and the engine block structure 312. This lack of side-loading minimises frictional forces and corresponding wear to the seals 358.

The first embodiment depicted in FIGS. 2A to 2C tends to be long because the chambers 250, 252, 254, 256 are in series, especially if a large stroke to bore ratio is used (for efficiency reasons). In some applications, this length would be a problem. Accordingly, the second embodiment provides a shorter coaxial engine 310. The engine 310 of the second embodiment is essentially the same as the engine 210 of the first embodiment except that the third and fourth chambers 254, 256 of the first embodiment have effectively been wrapped around the first and second chambers 250, 252 of the first embodiment to form two annular chambers 354, 356. The second embodiment is therefore shorter than the first embodiment.

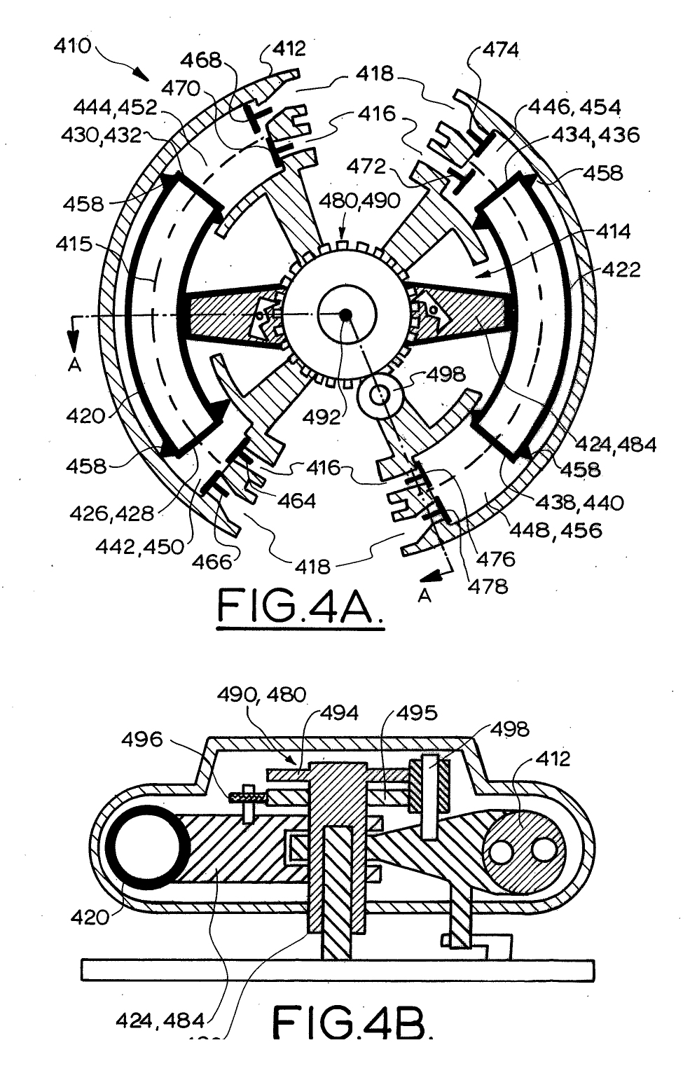

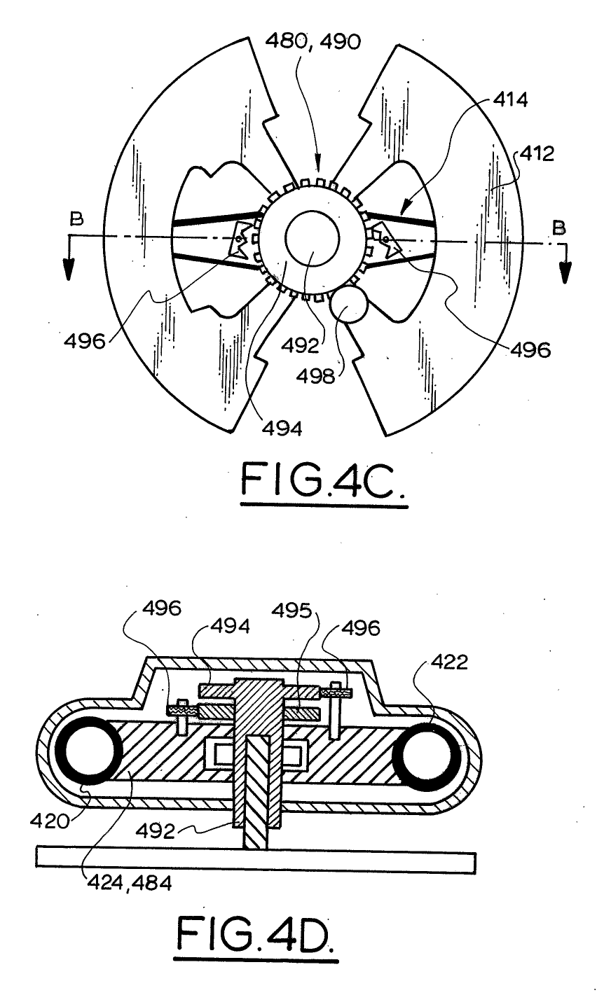

A third embodiment comprising a toroidal four stroke free piston internal combustion engine 410 is depicted in FIGS. 4A to 4D. The engine 410 comprises an engine block structure 412 and a rigid shuttle 414 mounted to the engine block structure 412 for reciprocal movement relative thereto along a circular shuttle centerline 415. The shuttle 414 is also pivotally mounted on a central shaft 492 via spokes 484. The engine 410 further comprises a selectively sealable network of inlet passages 416, which communicate with a fuel/air supply (not shown), and a selectively sealable network of outlet passages 418, which communicate with an exhaust system (not shown).

The shuttle 414 comprises a first shuttle part 420 in the general shape of a toroidal sector, a second shuttle part 422 in the general shape of a toroidal sector and a shuttle frame 424 rigidly fixing the first shuttle part 420 relative to the second shuttle part 422. Accordingly, the first and second shuttle parts 420, 422 cannot move relative to one another. The first and second shuttle parts 420, 422 are equally spaced around the shuttle centerline 415 from one another. The first shuttle part 420 has a first piston end 426, providing a generally circular first shuttle surface 428, and a second piston end 430, providing a generally circular second shuttle surface 432. The second shuttle part 422 has a third piston end 434, providing a generally circular third shuttle surface 436, and a fourth piston end 438, providing a generally circular fourth shuttle surface 440.

The engine block structure 412 includes a first cavity 442, in the general shape of a toroidal sector, housing the first piston end 426, a second cavity 444, in the general shape of a toroidal sector, housing the second piston end 430, a third cavity 446, in the general shape of a toroidal sector, housing the third piston end 434 and a fourth cavity 448, in the general shape of a toroidal sector, housing the fourth piston end 438. This arrangement defines four chambers, each in the general shape of a toroidal sector: a first chamber 450 bounded by the first cavity 442 and the first shuttle surface 428; a second chamber 452 bounded by the second cavity 444 and the second shuttle surface 432; a third chamber 454 bounded by the third cavity 446 and the third shuttle surface 436; and a fourth chamber 456 bounded by the fourth cavity 448 and the fourth shuttle surface 440. Low friction chamber seals 458, mounted on each of the piston ends 426, 430, 434, 438 ensure fluid isolation of each of the chambers 450, 452, 454, 456.

The first chamber 450 communicates with the network of inlet passages 416, via a first inlet valve 464, and with the network of outlet passages 418, via a first outlet valve 466. Similarly, the second chamber 452 communicates with the network of inlet passages 416, via a second inlet valve 468, and with the network of outlet passages 418, via a second outlet valve 470. The third chamber 454 communicates with the network of inlet passages 416, via a third inlet valve 472, and with the network of outlet passages 418, via a third outlet valve 474. Similarly, the fourth chamber 456 communicates with the network of inlet passages 416, via a fourth inlet valve 476, and with the network of outlet passages 418, via a fourth outlet valve 478.

As best shown in FIGS. 4B and 4D, a power extraction device 480 is provided in the form of a ratchet mechanism 490 on the shaft 492 adapted to convert reciprocating pivoting movement of the shuttle 414 into one-direction rotational motion. An additional power extraction device (not shown), such as an electromagnetic induction device, can also be provided between the shuttle 414 and the engine block structure 412. The ratchet mechanism 490 includes a first ratchet gear 494 mounted on the shaft 492 and a freely rotating second ratchet gear 495. An idler gear 498 is mounted on the engine block structure 412 and transfers drive from the second ratchet gear 495 to the first ratchet gear 494 and output shaft 492. Pawls 496 pivotally mounted on the shuttle 424 are spring loaded and can be set to provide clockwise, counter-clockwise or no rotation to the shaft 492. This translates the reciprocal motion of the shuttle 424 into single direction rotational output from the shaft 492. A torque absorber and vibration transmission damper may also be provided. Other means for converting reciprocating rotary motion into continuous rotary motion are well known to those skilled in the art. The result is that the power generated by the third embodiment, can be converted to mechanical torque for applications where this is the preferred output.

In operation, the shuttle 414 reciprocates with the same general cycle as described in relation to the example engine 110 with reference to FIGS. 1A to 1D, with FIG. 4A corresponding to the first stroke depicted in FIG. 1A. The shuttle 414 moves along the circular shuttle centerline 415 such that the center of pressure acting on the shuttle parts 420, 422 lies on the shuttle centerline 415. Further, the shuttle 414 is symmetrical and balanced about the shaft 480. Accordingly, there is no side-loading between the shuttle 414 and the engine block structure 412 and there are no unbalanced loads exerted on the shaft 480.

In the first and second embodiments, the shuttle 214, 314 reciprocates linearly backward and forward with each cycle. For some applications, it is desirable to convert this linear reciprocating motion into circular motion, such as for directly driving a car or in a conventional electrical generator. For this reason, the third embodiment provides a donut-shaped, or toroidal, engine 410. The third embodiment is essentially the same as the first embodiment except that the shuttle 214 is bent around to form a torus. This allows a rotational power output to be extracted from the third embodiment by way of a ratchet mechanism 490.

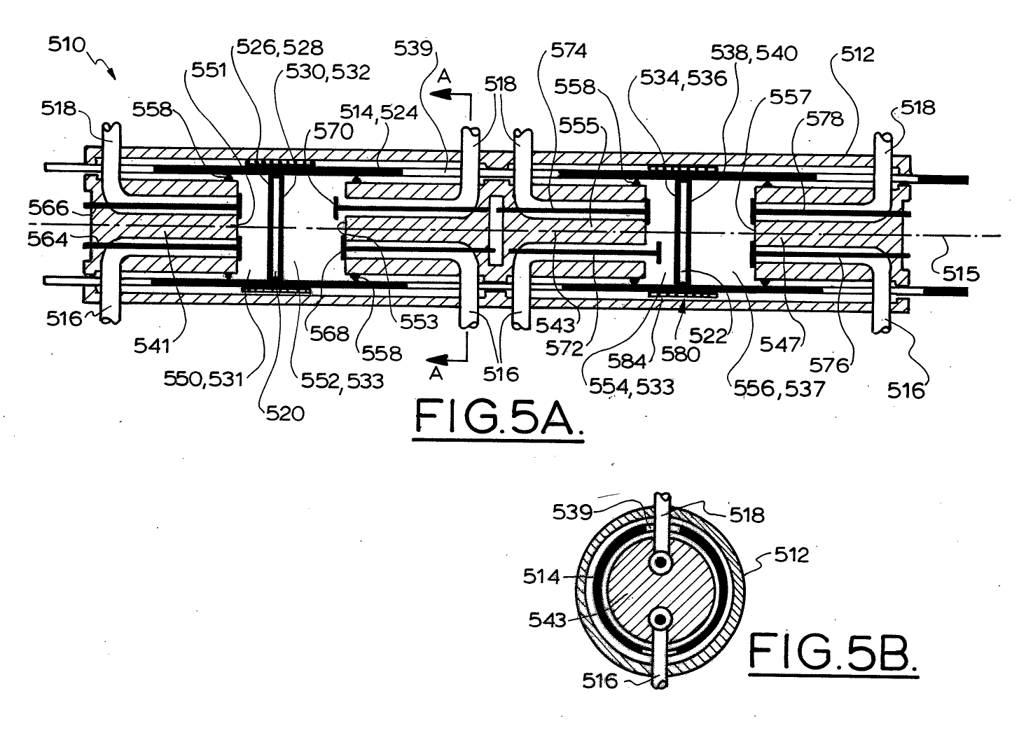

A fourth embodiment comprising a linear four stroke free piston internal combustion engine 510 is depicted in FIGS. 5A and 5B. The engine 510 comprises an engine block structure 512 and a shuttle 514 mounted to the engine block structure 512 for reciprocal movement relative thereto along a linear shuttle centerline 515. The engine 510 further comprises a selectively sealable network of inlet passages 516, which communicate with a fuel/air supply (not shown), and a selectively sealable network of outlet passages 518, which communicate with an exhaust system (not shown).

The shuttle 514 comprises a generally cylindrical first shuttle part 520, a generally cylindrical second shuttle part 522, axially spaced from the first shuttle part 520, and a generally tubular shuttle frame 524 rigidly fixing the first shuttle part 520 relative to the second shuttle part 522. Accordingly, the first and second shuttle parts 520, 522 cannot move relative to one another. The shuttle frame 524 defines a generally cylindrical space within its interior. The first and second shuttle parts 520, 522 are axially aligned along the shuttle centerline 515 and are arranged within the cylindrical space of the shuttle frame 524. The first shuttle part 520 has a first piston end 526, providing a generally circular first shuttle surface 528, and a second piston end 530, providing a generally circular second shuttle surface 532. The second shuttle part 522 has a third piston end 534, providing a generally circular third shuttle surface 536, and a fourth piston end 538, providing a generally circular fourth shuttle surface 540. The first and second shuttle parts 520, 522 are hollow to facilitate cooling of the shuttle parts 520, 522 by air or other fluid. The first and second shuttle parts 520, 522 are effectively partitions dividing the cylindrical space within the shuttle frame 524 into a first shuttle end cavity 531, a shuttle middle cavity 533 and a second shuttle end cavity 537. Longitudinal apertures 539 are formed in the shuttle frame 524 to provide access to the shuttle middle cavity 533.

The engine block structure 512 includes a first outer block portion 541, an inner block portion 543 and a second outer block portion 547. The inner block portion 543 is located within the shuttle middle cavity 533 and has a generally circular first end face 553 and a generally circular second end face 555. The first outer block portion 541 extends into the first shuttle end cavity 531 and has a generally circular end face 551 opposing the first end face 553 of the inner block portion 543. The second outer block portion 547 extends into the second shuttle end cavity 537 and has a generally circular end face 557 opposing the second end face 555 of the inner block portion 543. The inner block portion 543 is supported by the engine block structure 512 via the apertures 539.

The first shuttle part 520 is arranged between the end face 551 of the first outer block portion 541 and the first end face 553 of the inner block portion 543. The second shuttle part 522 is arranged between the end face 557 of the second outer block portion 547 and the second end face 555 of the inner block portion 543. This arrangement defines four generally cylindrical chambers: a first chamber 550 bounded by the end face 551 of the first outer block portion 541, the shuttle frame 524 and the first shuttle surface 528; a second chamber 552 bounded by the first end face 553 of the inner block portion 543, the shuttle frame 524 and the second shuttle surface 532; a third chamber 554 bounded by the second end face 555 of the inner block portion 543, the shuttle frame 524 and the third shuttle surface 536; and a fourth chamber 556 bounded by the end face 557 of the second outer block portion 547, the shuttle frame 524 and the fourth shuttle surface 540. Low friction chamber seals 558, mounted on the inner and outer block portions 541, 543, 547 ensure fluid isolation of each of the chambers 550, 552, 554, 556.

The first chamber 550 communicates with the network of inlet passages 516, via a first inlet valve 564, and with the network of outlet passages 518, via a first outlet valve 566. Similarly, the second chamber 552 communicates with the network of inlet passages 516, via a second inlet valve 568, and with the network of outlet passages 518, via a second outlet valve 570. The third chamber 554 communicates with the network of inlet passages 516, via a third inlet valve 572, and with the network of outlet passages 518, via a third outlet valve 574. Similarly, the fourth chamber 556 communicates with the network of inlet passages 516, via a fourth inlet valve 576, and with the network of outlet passages 518, via a fourth outlet valve 578.

A power extraction device 580 is provided in the engine block structure 512. The power extraction device 580 is depicted in the form of a reversible electromagnetic induction device, comprising magnets 584 provided on the shuttle frame 524 and induction coils (not shown) provided in the engine block structure 512 adjacent the magnets 584.

In operation, the shuttle 514 reciprocates with the same general cycle as described in relation to the example engine 110 with reference to FIGS. 1A to 1D, with FIG. 5A corresponding to the first stroke depicted in FIG. 1A.

In this embodiment, the full surface area of the outside of the shuttle 514 is available for the power extractions means 580 to act on, thus making it easier to extract energy compared to the example engine 110. The bore seals 162 of the example engine 110 are eliminated in this embodiment, and the chamber seals 558 are stationary, being fixed to the engine block structure 512, unlike the chamber seals in the example engine 110 and in the second, third and fourth embodiments, which are attached to the moving shuttle parts 120, 122, 220, 222, 320, 322, 420, 422. This means that the sealing method, such as (piston) rings, and any necessary lubricating fluids are stationary and thus, the rings are easier to service and the lubricating fluids easier to supply.

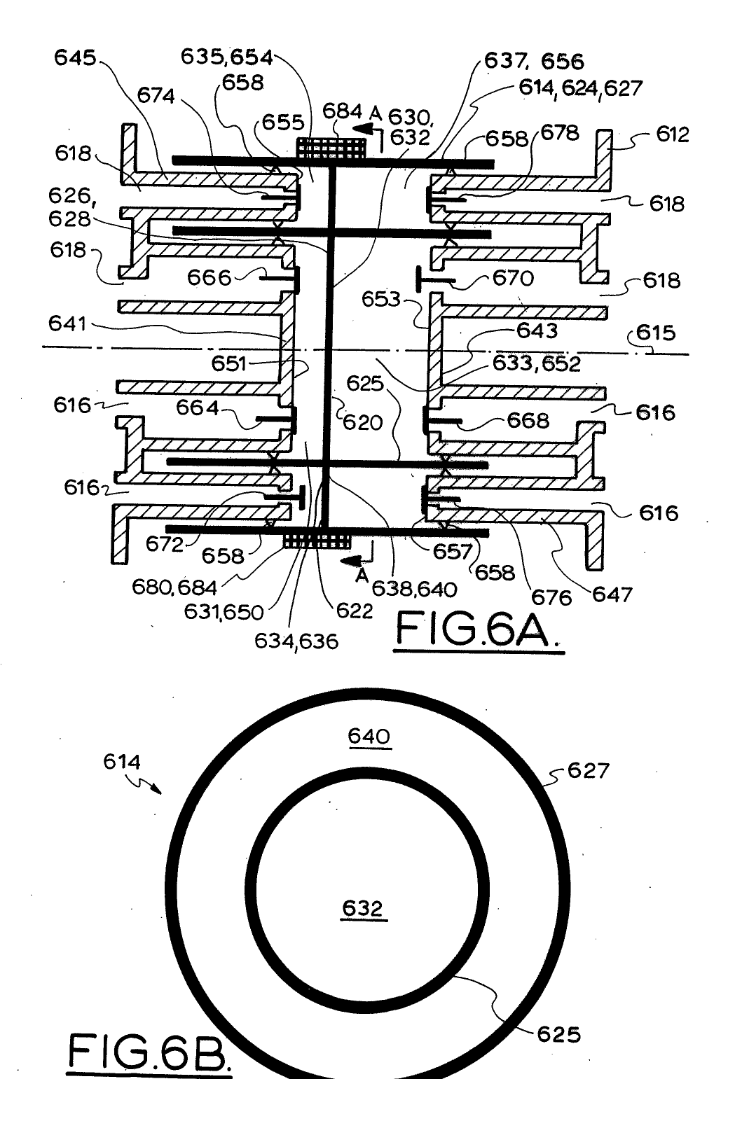

A fifth embodiment comprising a coaxial four stroke free piston internal combustion engine 610 is depicted in FIGS. 6A and 6B. The engine 610 comprises an engine block structure 612 and a rigid shuttle 614 mounted to the engine block structure 612 for reciprocal movement relative thereto along a linear shuttle centerline 615. The engine 610 further comprises a selectively sealable network of inlet passages 616, which communicate with a fuel/air supply (not shown), and a selectively sealable network of outlet passages 618, which communicate with an exhaust system (not shown).

The shuttle 614 comprises a generally cylindrical first shuttle part 620, a generally annular second shuttle part 622 and a shuttle frame 624, having a generally tubular inner frame wall 625 and a generally tubular outer frame wall 627 of greater diameter than the inner frame wall 625 arranged around the inner frame wall 625. The inner and outer frame walls 625, 627 are coaxially aligned along the shuttle centerline 615, defining a generally cylindrical space within the inner frame wall 625 and a generally annular space between the inner frame wall 625 and the outer frame wall 627. The shuttle frame 624 rigidly fixes the first shuttle part 620 relative to the second shuttle part 622. Accordingly, the first and second shuttle parts 620, 622 cannot move relative to one another. The first and second shuttle parts 620, 622 are coaxially aligned along the shuttle centerline 615 and are arranged within the cylindrical and annular spaces, respectively, of the shuttle frame 624. The first shuttle part 620 has a first piston end 626, providing a generally circular first shuttle surface 628, and a second piston end 630, providing a generally circular second shuttle surface 632. The second shuttle part 622 has a third piston end 634, providing a generally annular third shuttle surface 636, and a fourth piston end 638, providing a generally annular fourth shuttle surface 640. As with the shuttle parts 520, 522 of the fourth embodiment, the shuttle parts 620, 622 of the fifth embodiment can also be hollow to facilitate cooling. The first and second shuttle parts 620, 622 are effectively partitions: the first shuttle part 620 dividing the cylindrical space within the inner frame wall 625 into a first shuttle inner cavity 631 and a second shuttle inner cavity 633; and the second shuttle part 622 dividing the annular space between the inner frame wall 625 and the outer frame wall 627 into a first shuttle outer cavity 635 and a second shuttle outer cavity 637.

The engine block structure 612 includes a first inner block portion 641, a second inner block portion 643, a first outer block portion 645 and a second outer block portion 647. The first inner block portion 641 extends into the first shuttle inner cavity 631 and has a generally circular end face 651. The second inner block portion 643 extends into the second shuttle inner cavity 633 and has a generally circular end face 653 opposing the end face 651 of the first inner block portion 641. The first outer block portion 645 extends into the first shuttle outer cavity 635 and has a generally annular end face 655. The second outer block portion 647 extends into the second shuttle outer cavity 637 and has a generally annular end face 657 opposing the end face 655 of the first outer block portion 645.

The first shuttle part 620 is arranged between the end face 651 of the first inner block portion 641 and the end face 653 of the second inner block portion 643. The second shuttle part 622 is arranged between the end face 655 of the first outer block portion 645 and the end face 657 of the second outer block portion 647. This arrangement defines two generally cylindrical chambers and two generally annular prismatic chambers: a first chamber 650 bounded by the end face 651 of the first inner block portion 641, the inner frame wall 625 and the first shuttle surface 628; a second chamber 652 bounded by the end face 653 of the second inner block portion 643, the inner frame wall 625 and the second shuttle surface 632; a third chamber 654 bounded by the end face 655 of the first outer block portion 645, the inner frame wall 625, the outer frame wall 627 and the third shuttle surface 636; and a fourth chamber 656 bounded by the end face 657 of the second outer block portion 647, the inner frame wall 625, the outer frame wall 627 and the fourth shuttle surface 640. Low friction chamber seals 658, mounted on the inner and outer block portions 641, 643, 645, 647 ensure fluid isolation of each of the chambers 650, 652, 654, 656.

The first chamber 650 communicates with the network of inlet passages 616, via a first inlet valve 664, and with the network of outlet passages 618, via a first outlet valve 666. Similarly, the second chamber 652 communicates with the network of inlet passages 616, via a second inlet valve 668, and with the network of outlet passages 618, via a second outlet valve 670. The third chamber 654 communicates with the network of inlet passages 616, via a third inlet valve 672, and with the network of outlet passages 618, via a third outlet valve 674. Similarly, the fourth chamber 656 communicates with the network of inlet passages 616, via a fourth inlet valve 676, and with the network of outlet passages 618, via a fourth outlet valve 678.

A power extraction device 680 is provided in the engine block structure 612. The power extraction device 680 is depicted in the form of a reversible electromagnetic induction device, comprising magnets 684 provided on the shuttle frame 624 and induction coils (not shown) provided in the engine block structure 612 adjacent the magnets 684.

In operation, the shuttle 614 reciprocates with the same general cycle as described in relation to the example engine 110 with reference to FIGS. 1A to 1D, with FIG. 6A corresponding to the first stroke depicted in FIG. 1A.

The fourth embodiment depicted in FIGS. 5A and 5B tends to be long because the chambers 550, 552, 554, 556 are in series, especially if a large stroke to bore ratio is used (for efficiency reasons). In some applications, this length would be a problem. For this reason, the fifth embodiment provides an alternative, shorter coaxial engine 610. The engine 610 of the fifth embodiment is essentially the same as the engine 510 of the fourth embodiment, except that the third and fourth chambers 554, 556 of the fourth embodiment have effectively been wrapped around the first and second chambers 550, 552 of the fourth embodiment, to form two annular chambers 654, 656. The fifth embodiment is therefore more compact than the fourth embodiment.

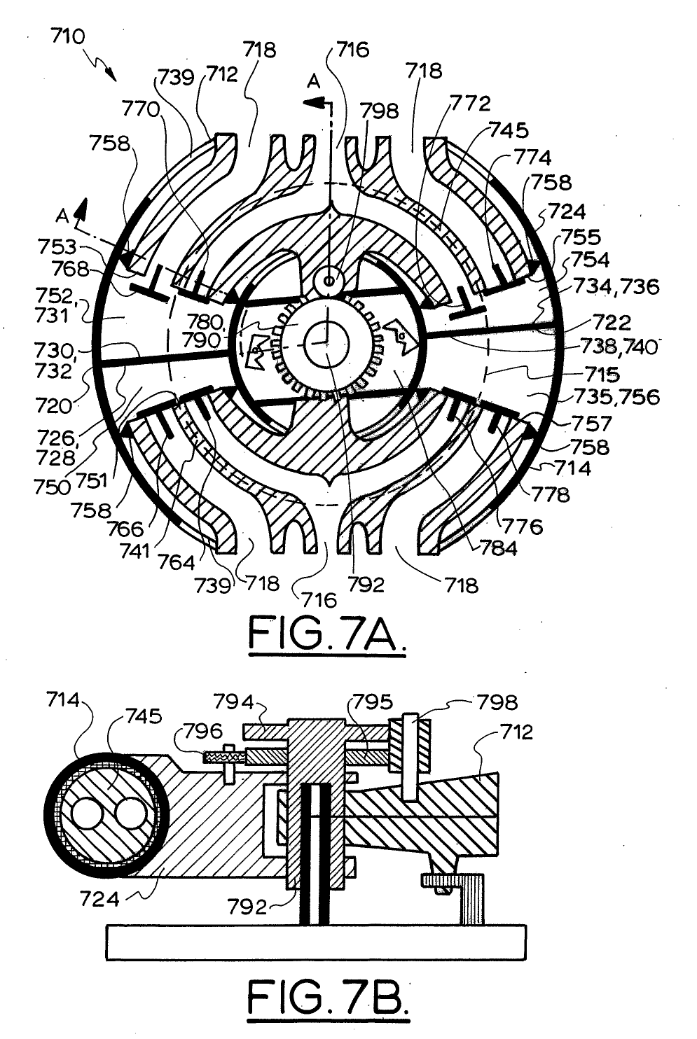

A sixth embodiment comprising a toroidal four stroke free piston internal combustion engine 710 is depicted in FIGS. 7A and 7B. The engine 710 comprises an engine block structure 712 and a rigid shuttle 714 mounted to the engine block structure 712 for reciprocal movement relative thereto along a circular shuttle centerline 715. The shuttle 714 is also pivotally mounted on a central shaft 792 via spokes 784. The engine 710 further comprises a selectively sealable network of inlet passages 716, which communicate with a fuel/air supply (not shown), and a selectively sealable network of outlet passages 718, which communicate with an exhaust system (not shown).

The shuttle 714 comprises a first shuttle part 720 in the general shape of a toroidal sector, a second shuttle part 722 in the general shape of a toroidal sector and a hollow, generally toroidal shuttle frame 724, which defines a generally toroidal space within the shuttle frame 724. The first and second shuttle parts 720, 722 are equally spaced around the shuttle centerline 715 from one another and are arranged within the toroidal space of the shuttle frame 724. The shuttle frame 724 rigidly fixes the first shuttle part 720 relative to the second shuttle part 722. Accordingly, the first and second shuttle parts 720, 722 cannot move relative to one another. The first shuttle part 720 has a first piston end 726, providing a generally circular first shuttle surface 728, and a second piston end 730, providing a generally circular second shuttle surface 732. The second shuttle part 722 has a third piston end 734, providing a generally circular third shuttle surface 736, and a fourth piston end 738, providing a generally circular fourth shuttle surface 740. As with the shuttle parts 520, 522 of the fourth embodiment, the shuttle parts 720, 722 of the sixth embodiment can also be hollow to facilitate cooling. The first and second shuttle parts 720, 722 are effectively partitions dividing the toroidal space within the shuttle frame 724 into a first shuttle cavity 731 and a second shuttle cavity 735. Longitudinal apertures 739 are formed in the shuttle frame 724 to provide access to the first and second shuttle cavities 731, 735.

The engine block structure 712 includes a first block portion 741 and a second block portion 745. The first block portion 741 is located within the first shuttle cavity 731 and has a generally circular first end face 751 and a generally circular second end face 757. The second block portion 745 is located within the second shuttle cavity 735 and has a generally circular first end face 753 and a generally circular second end face 755. The first and second block portions 741, 745 are supported by the engine block structure 712 via the apertures 739.

The first shuttle part 720 is arranged between the first end face 751 of the first block portion 741 and the first end face 755 of the second block portion 745. The second shuttle part 722 is arranged between the second end face 753 of the first block portion 741 and the second end face 757 of the second block portion 745. This arrangement defines four chambers, each in the general shape of a toroidal sector: a first chamber 750 bounded by the first end face 751 of the first block portion 741, the shuttle frame 724 and the first shuttle surface 728; a second chamber 752 bounded by the first end face 753 of the second block portion 745, the shuttle frame 724 and the second shuttle surface 732; a third chamber 754 bounded by the second end face 755 of the second block portion 745, the shuttle frame 724 and the third shuttle surface 736; and a fourth chamber 756 bounded by the second end face 757 of the first block portion 741, the shuttle frame 724 and the fourth shuttle surface 740. Low friction chamber seals 758, mounted on the each of the block portions 741, 745 ensure fluid isolation of each of the chambers 750, 752, 754, 756.

The first chamber 750 communicates with the network of inlet passages 716, via a first inlet valve 764, and with the network of outlet passages 718, via a first outlet valve 766. Similarly, the second chamber 752 communicates with the network of inlet passages 716, via a second inlet valve 768, and with the network of outlet passages 718, via a second outlet valve 770. The third chamber 754 communicates with the network of inlet passages 716, via a third inlet valve 772, and with the network of outlet passages 718, via a third outlet valve 774. Similarly, the fourth chamber 756 communicates with the network of inlet passages 716, via a fourth inlet valve 776, and with the network of outlet passages 718, via a fourth outlet valve 778.

As best shown in FIG. 7B, a power extraction device 780 is provided in the form of a ratchet mechanism 790 on the shaft 792 adapted to convert reciprocating pivoting movement of the shuttle 714 into one-direction rotational motion, similar to that shown in FIGS. 4A to 4D. An additional power extraction device (not shown), such as an electromagnetic induction device, can also be provided between the shuttle 714 and the engine block structure 712. The ratchet mechanism 790 includes a first ratchet gear 794, mounted on the shaft 792 and a freely rotating second ratchet gear 795. An idler gear 798 is mounted on the engine block structure 712 and transfers drive from the second ratchet gear 795 to first ratchet gear 794 and output shaft 792. Pawls 796 pivotally mounted on the shuttle 724 are spring loaded and can be set to provide clockwise, counter clockwise or no rotation to the shaft 792. This translates the reciprocal motion of the shuttle 724 into single direction rotational output from the shaft 792. A torque absorber and vibration transmission damper may also be provided. Other means for converting reciprocating rotary motion into continuous rotary motion are well known to those skilled in the art. The result is that the power generated by the sixth embodiment, can be converted to mechanical torque for applications where this is the preferred output.

In operation, the shuttle 714 reciprocates with the same general cycle as described in relation to the example engine 110 with reference to FIGS. 1A to 1D, with FIG. 7A corresponding to the first stroke depicted in FIG. 1A.

In the fourth and fifth embodiments, the shuttle 514, 614 reciprocates linearly backward and forward with each cycle. For some applications it is desirable to convert this linear reciprocating motion into circular motion, such as for directly driving a car or in a conventional electrical generator. For this reason, the sixth embodiment provides a donut-shaped (toroidal) engine 710. This embodiment is essentially the same as the fourth embodiment, except that the piston shuttle 514 is bent around into a torus. The first, second, fourth and fifth embodiments can also be associated with a power extraction device comprising a ratchet mechanism similar to those described in relation to the third and sixth embodiments. This mechanical power extraction means for the linear embodiments shown in FIGS. 2, 3, 5, 6, converts the relative reciprocating motion of the shuttle frame with respect to the engine block into one-way rotary motion of a shaft. This conversion is achieved by use of ratchets that engage the shaft gearing when the relative linear motion of the shuttle with respect to the engine block is sufficient to add torque to the shaft, with a reversing gear to ensure one-way rotation. The ratchet engagement mechanism is symmetrically arranged around the shaft so as not to add side-loading to the shuttle. A flywheel or similar means can be added to the shaft to ensure smooth rotation from the cyclic ratchet engagement. This mechanical power extraction of the linear embodiments shown in FIGS. 2, 3, 5, 6 is similar to that shown for the toroidal embodiments shown in FIGS. 4 and 7. Many similar mechanisms for converting linear reciprocating motion to smooth one-way rotational motion of a shaft are known to those versed in the art.

One of the major advantages of the first, second and third embodiments compared to the example engine, is that the seals are relatively easily lubricated and the moving shuttle is more easily cooled. For example, referring to FIG. 2A, the seals 258 can be lubricated by spraying oil onto the exposed shuttle parts 220, 222 to form a thin lubricating film. A combination of surface tension and acceleration forces will spread the oil film to the seal 258 and the chamber walls, in much the same manner that crank case splash distributes oil from the sump to the cylinder walls in a crank engine. Also, because the shuttle parts 220, 222 are exposed, they can be air cooled by the air in the space around the shuttle parts 220, 222. This air cooling can be enhanced by design features, such as fins, which increase the surface area involved in the cooling.

Referring to FIG. 5, the seal 558 is attached to the engine block structure 512 and is therefore stationary (except for recoil motion). As a result, lubricating fluids, such as oil or air can be fed to the seals 558 by narrow channels (not shown) embedded in the engine block structure 512 from external pressurised reservoirs (not shown). This applies equally to the fifth and sixth embodiments. Air is particularly attractive as a lubricating fluid because it is readily available, non-polluting, low friction and is a zero wear lubricant. Alternatively, oil can be sprayed onto the inside surface of the shuttle frame 224 to provide the necessary lubrication. Because the outer surface of the shuttle frame 224 is exposed to air, it has the advantage of being air cooled with a larger surface area than the first, second and third embodiments. Again, fins may be employed to enhance air cooling. Dry lubricants can also be used in all embodiments, however, they generally involve higher friction and wear properties.

In a crank engine, the piston in the cylinder is commonly sealed by using one or more lubricated, spring-loaded piston rings. In addition, because of the side loading forces in a crank engine, the piston skirt is in sliding contact with the cylinder walls, and so the skirt also contributes to the piston friction. In the present invention, there is no significant side loading on the piston, so a different type of sliding seal with much lower friction can be used instead. Such an alternative seal consists of a flexible, spring-loaded lip or flange in contact with the cylinder wall and anchored to the rim of the piston top. The gas pressure in the chamber pushes the flange against the cylinder wall, thus providing a type of self-sealing seal that moves with the piston, while sliding along the cylinder wall. Under neutral chamber pressure, the spring-loading holds the flange against the piston wall. This type of self-sealing piston seal is commonly used in bicycle pumps, or other pumps that do not have a significant side-loading, and are well known to those versed in the art. A self-sealing flange seal can be advantageously employed in any of the above embodiments, although standard piston rings are also possible. Flange seals are advantageous because they exhibit lower friction, lower wear and no crevices for accumulating unburned gases. In either sealing arrangement, the piston skirt should not be in contact with the cylinder walls, as this would add to the piston friction and wear without any side-load support benefit.

In all of the above embodiments, the inlet and outlet valves are located on the same face of the respective chambers. An alternative is to relocate the inlet valves to the shuttle surface of the shuttle parts and to expand the area controlled by the valves. For example, referring to FIG. 2A, in chamber 250, the inlet valve 264 would be moved to the first piston end 226 and both the outlet valve 266 and the relocated inlet valve 264 expanded to provide a larger inlet/outlet area. Similar inlet valve relocations can occur in all of the above embodiments. This alternative inlet valve location provides greater area for the gases to enter and leave the combustion chambers, giving lower pumping losses and less turbulence than the standard side by side positioning. The relocated inlet valve operation can be automatically powered by both the gas pressure difference, and the inertia of the valve itself, or can be externally powered. A latch and release mechanism can be used to control the opening and closing of the inlet valve at the desired point inner cycle. Because this inlet valve control mechanism is located on the moving shuttle, this alternative valve location is more difficult to operate than the standard side by side positioning.

In each of the above embodiments, during any stroke in the cycle of the engine, there is always one chamber undergoing expansion, another undergoing compression, another undergoing exhaust, and the remaining one taking in a fresh charge, and during the course of a cycle, each chamber will separately undergo each of the four operations (expansion, exhaust, intake, compression). Thus every stroke in this cycle is a power stroke, with only the difference in energy between expansion and compression being extracted by the power extraction device. This avoids the need to separately store energy and return it to power the compression, exhaust and intake strokes, along with all the energy conversion losses this would entail.

In each embodiment, there is essentially only one moving part, apart from the valves, being the shuttle. Unlike crank engines, the forces accelerating the shuttle are acting in the direction of acceleration, so that there is no side loading on the shuttle, and thus, comparatively less friction and wear with the chamber walls. Also, unlike conventional engines, there is no load on crank bearings, because there is no crank or bearing. The absence of a crank also means that the expansion of the hot gases is faster than for a crank engine. This is because the shuttle accelerates more rapidly, so that the chamber walls are exposed to high temperature gas for less time, leading to reduced heat transfer to the walls.

In all of the embodiments, the first and second shuttle surfaces are preferably congruent and the third and fourth shuttle surfaces are also preferably congruent. This ensures that opposing chambers have the same dimensions and facilitates achieving a consistent power stroke from each chamber.

Advantageously, the preferred mode of energy/power output is through flexible electrical, or fluid cables, so that the power output is not rigidly coupled to the engine block structure. This means that if the engine is mounted on compliant or low-friction sliding supports, the engine block can rock backward and forward in opposite phase to the shuttle, without transmitting significant vibrational energy to the engine mounting. Using a compliant or low-friction sliding mounting obviates the need for any vibration cancelling means. If needed, vibrational cancelling means, such as oscillating counterweights, could be provided. However, either of the toroidal engines 410, 710 can allow direct mechanical coupling of the power output, and so some method to counterbalance the oscillating output torque may be necessary in this case, depending on the application. Such a counterbalancing means can be provided by an oscillating flywheel mounted on the shaft 492, 792, and driven with the opposite phase and angular momentum as the engine itself Alternatively, in any embodiment, the engine may be doubled, creating eight chamber versions where the pair of shuttles in the doubled configuration reciprocate in opposite phase, so as to cancel any vibration.

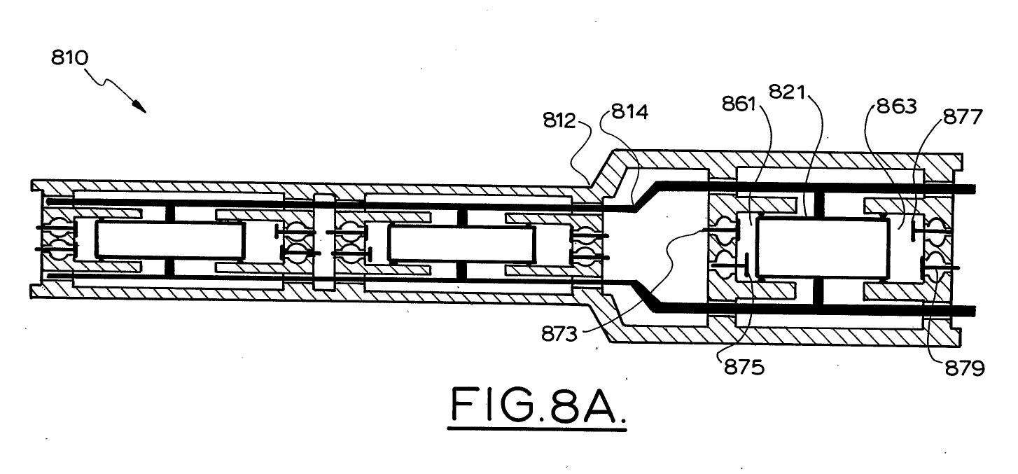

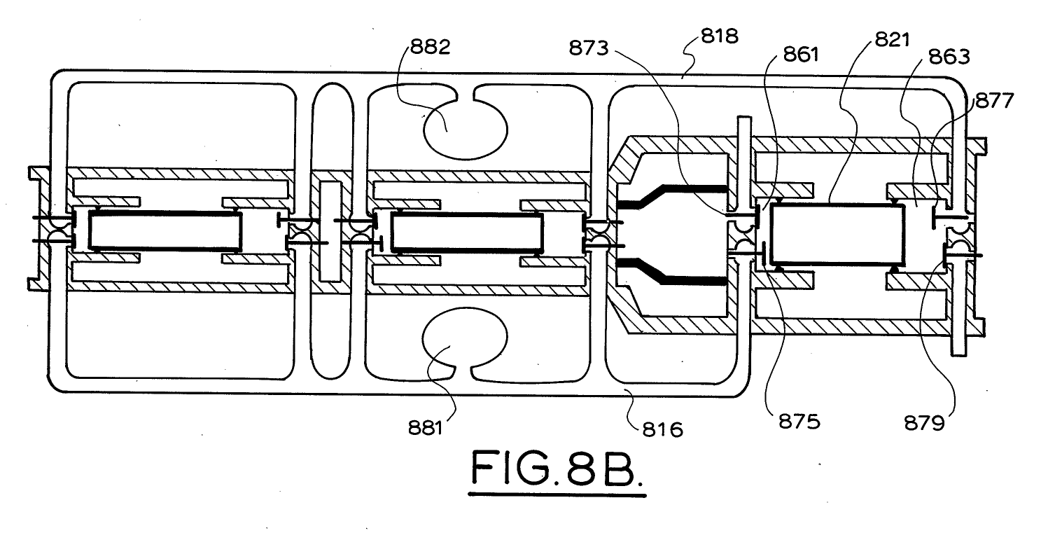

The combustion for driving the shuttle of the engine of each of the above described embodiments is preferably created by homogeneous charge compression ignition (HCCI), or alternatively by conventional spark ignition (SI) or diesel fuel injection. When using HCCI as the ignition method, the necessary compression ratios can be very high—typically in the range 20:1 to 30:1. With such high compression ratios, the clearance gap at the end of the compression stroke can be so small that there is significant heat loss to the chamber walls, depending on the overall scale of the engine and the stroke to bore ratio. In order to avoid such a small clearance gap, the engine can be modified to give staged compression and expansion (also known as super-charging). FIGS. 8A and 8B depict the second embodiment with a super-charging modification. FIG. 8B is a cross-sectional view of the engine 810 taken at an angle offset from the cross-sectional view of FIG. 8A in order to show the network of inlet passages 816 and outlet passages 818. The engine 810 comprises a third piston part 821 with an associated fifth chamber 861 and opposing sixth chamber 863. A fifth inlet valve 873 and fifth outlet valve 875 are arranged in the fifth chamber 861 and a sixth inlet valve 877 and a sixth outlet valve 879 are arranged in the sixth chamber 863. The fifth outlet valve 875 is in fluid communication with the network of inlet passages 816 and the sixth inlet valve 877 is in fluid communication with the network of outlet passages 818. The fifth inlet valve 873 is in fluid communication with an inlet manifold (not shown) and the sixth outlet valve 879 is in fluid communication with an exhaust manifold (not shown), which would contain any exhaust cleanup and muffler components. Compression of the fifth chamber 861 is driven by the expansion of the sixth chamber 863, which results from the pressure in the network of outlet passages 818 being greater than the pressure in the network of inlet passages 816. A fresh charge is drawn into the fifth chamber 861 via the fifth inlet valve 873 and the expanded exhaust from the sixth chamber 863 exits via the sixth outlet valve 879. The transfer of charges between the supercharger and the combustion chambers is buffered by reservoirs 881. The first stage compression/expansion embodiment shown in FIG. 8 is of a reciprocating piston type, but a compression expansion turbine could also substitute, as is common practice for supercharged engines.

If the power output of the engine needs to be varied over a wide range, as in automotive applications, for example, then there are a number of methods of doing so. One method consists of turning the engine on or off when power is needed or not needed, such as when idling. This method is particularly easy if the power output of the engine is buffered, as described below, because then some power is available, for short durations, even when the engine is not running. Another method of varying the power output is to vary the fuel/air mixture ratio. Very lean mixtures give lower power output, while rich mixture gives higher power output. This method of varying the power output is limited at the rich mixture end by the onset of knocking or exceeding maximum design pressure, and at the lean mixture end by insufficient power to overcome losses. Because a given engine will have an optimal efficiency operating mixture ratio, this method of varying power output will involve some compromise between desired power and efficiency.

A further method of varying power output based on the Miller Cycle, controls how much of the input charge is retained in a chamber by keeping the inlet valve open for part of the compression stroke. This allows some of the charge that was drawn into the chamber to be pushed back into the inlet manifold before the valve closes and compression begins. Alternatively, the inlet valve could close early, preventing a full charge from entering the chamber. Either way, less than a full charge is present when compression begins. However, the expansion of the combustion gases produced by this partial charge continues until the shuttle part reaches the end of the chamber. Ideally, the expanded gas is at atmospheric pressure when the expansion is complete and the exhaust valve is opened, so that all of the energy inherent in the compressed gas is transferred to the shuttle. By designing the engine to normally operate on the Atkinson/Miller cycle, there is a power reserve available by increasing the amount of charge retained in a chamber by changing the valve timing. An increased charge means increased power output, but this increase is achieved at the cost of lower efficiency relative to the complete Miller cycle. With variable valve timing, operation anywhere between Atkinson/Miller and the standard Otto cycle is possible. Advantageously, the engine can normally operate with a full Miller cycle, and thus gain maximum efficiency, but shift this cycle toward the Otto cycle by using valve timing when more power is needed. Any combination or separate use of these power-output variation methods could be used, depending on the application.

Startup of the engine is particularly easy if the power extraction device is reversible—that is, if it can accept energy input and turn this into kinetic energy of the shuttle. In the case of an electrical energy power extraction devices, this means that the power extraction device acts as either a generator (normal operation) or as an electric motor (startup). Because the engine has only one low mass part to drive during startup (the shuttle), this does not require as much startup energy as a crank engine.

Many methods are possible for stopping the engine. One method is not opening the inlet valves, so that no fresh charge is drawn into the corresponding chamber. This method is particularly easy to implement if variable valve timing is used for implementing the Miller cycle, since then the valves are already completely controlled. Another method is to extract more energy from the shuttle than that provided by the expanding gases, thus slowing and eventually stopping the shuttle. Other methods equivalent to a brake could be used.

Many different forms of power extraction device can be employed, including electrical, pneumatic, hydraulic and mechanical power extraction devices. One means is electrical energy conversion, having the advantages that electrical power output is useful in many applications, is relatively inexpensive to make, and has high energy conversion efficiency. With electromagnetic coupling between the moving shuttle and the stationary power extraction device, there does not have to be physical contact between the shuttle and the power extraction device. One method of electromagnetic coupling is to have coils in the engine block structure, and permanent magnetic strips of alternating polarity on the shuttle. As the shuttle moves, its magnetic field induces current in the coils and the fields generated by this current oppose the motion of the shuttle, thus converting the shuttle kinetic energy into electrical energy. Alternative arrangements with the coils on the piston shuttle, and permanent magnets on the engine block structure are also possible and have the advantage of moving the higher mass component to the static element, but with the disadvantage of having to provide electrical contacts to the moving shuttle. The electric power being removed can be sensed and controlled (e.g., by switching) to ensure that the optimal amount of energy is removed on each stroke. The same sensing and control device can also be used during startup to ensure sufficient energy is fed to the shuttle to reach operating values. Other arrangements are possible, similar to various forms of electric motor/generator designs flattened into a linear form. Many of these alternative motor/generator designs use induced magnetic fields rather than expensive (and heavy) permanent magnets. These various electromagnetic energy conversion means are well known to those versed in the art.

Since the shuttle motion varies in speed throughout a stroke, the electrical current produced by the electrical power extraction device will typically be alternating current of varying frequency and voltage, which is not a suitable power output for most electrical applications. One method of turning this varying power output into a useful power supply is to rectify the AC current and use the rectifier output to charge a large capacitor, then use the capacitor as a power source. In effect, the capacitor acts as an energy buffer between the output from the engine and the application load, in much the same way that a flywheel acts as a mechanical energy buffer for a standard crank engine. In hybrid car applications, if a very large capacitor is used, it can also act as a high power energy storage device (for regenerative braking) or a short-term power reserve for rapid acceleration. Another energy storage device that buffers the oscillatory power output of the engine from the load is a flywheel. Energy can be added or removed from the flywheel electrically, pneumatically, hydraulically or mechanically.

An alternative power extraction device converts the shuttle motion into compressed air pressure. One such device would involve additional piston cylinder arrangements to the moving shuttle to act as a compressor. For example, in the coaxial engine 310, another annular layer of piston/cylinder can be added to form a double-sided compression chamber. Valves in the engine block structure would let fresh air in and compressed air out. The output compressed air can be fed to a separate compressed air storage chamber, which acts as a buffer between the varying output pressure from the oscillating compressor and the application load. As in the electric output case, the amount of air being compressed at the current buffer pressure must be controlled (through valve timing) to extract the optimal energy from each stroke. Yet another energy conversion means is to use hydraulic pressure. This would function essentially the same as for compressed air, as a person skilled in the art would understand.

Alternatively, the linear oscillating motion could be converted to oscillating rotary motion by means of a wheel or pinion in contact with the shuttle. Preferably, this contact is arranged so as not to create side-loading on the shuttle. This oscillating rotary motion can then be converted to electrical energy by a variable speed generator, or to one-way rotary motion for output as mechanical torque. For all the power extraction means, it is generally advantageous to buffer the power output through some energy storage means between the engine and the application load. Such an energy buffer ensures that the load power is no longer directly tied to the engine power output. This means that the instantaneous application power can exceed the engine power, with the difference being drawn from the energy buffer. Likewise, if the application momentarily generates power rather than consuming it (as for example in regenerative braking), the energy buffer can store the extra energy for later use. Such an energy storage means is also useful for supplying power during engine startup. For an electrical power system, large capacitors or an electrically coupled flywheel are suitable energy storage means; for pneumatic or hydraulic power systems, compressed gases are a suitable energy storage means, and for a mechanical power system, flywheel energy storage means is suitable.

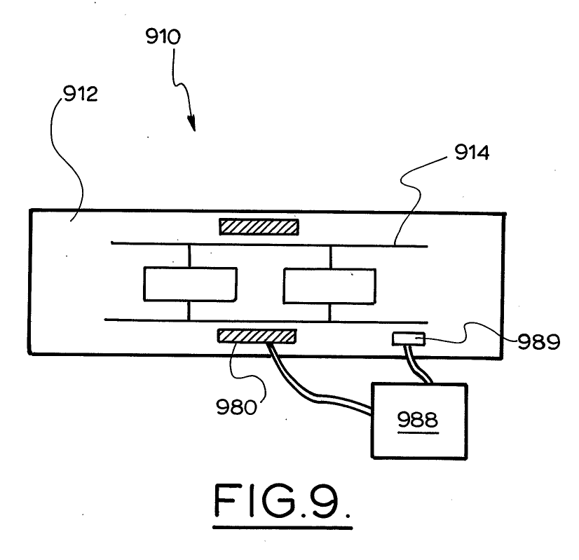

As depicted in FIG. 9, the power extraction device 980 may be provided with a feedback controller 988, to control the amount of energy extracted per stroke. A sensor 989 provided in the engine block structure 912 senses the shuttle speed and the power extraction device 980 extracts more or less kinetic energy per stroke depending on whether the shuttle 914 speed is above or below respectively a set optimal speed. The set speed is selected to provide the optimal efficiency or power out for the current fuel-air ratio, as desired. If the controller 988 extracts too much energy per stroke, the shuttle 914 will slow and eventually have insufficient kinetic energy to cause ignition. At this point the engine 910 will misfire, and quickly come to a stop. Thus the feedback controller 988 can also be used to switch the engine 910 off. Likewise, during startup, the feedback controller 988 adds energy on each stroke, until the shuttle 914 achieves enough kinetic energy to induce ignition. That is, by adding energy per stroke, rather than extracting it, the controller 988 can also start the engine 910. If too little energy is extracted per stroke, the shuttle 914 will speed up until friction and pumping losses establish a new equilibrium operating speed.

1: A four-stroke free piston internal combustion engine having:
an engine block structure;
a shuttle mounted to said engine block structure to enable reciprocation of said shuttle relative to said engine block structure, said shuttle having a first shuttle part with first and second opposite shuttle surfaces, a second shuttle part with third and fourth opposite shuttle surfaces, a shuttle frame connecting said first and second shuttle parts such that the shuttle parts are fixed relative to one another, and a shuttle centerline extending centrally of all four said shuttle surfaces and along which said shuttle is adapted to reciprocate;
a first chamber formed between said first shuttle surface and said engine block structure;
a second chamber formed between said second shuttle surface and said engine block structure;
a third chamber formed between said third shuttle surface and said engine block structure;
a fourth chamber formed between said fourth shuttle surface and said engine block structure; and
an arrangement of selectively sealable inlet and outlet fluid passages communicating with each of said chambers, said shuttle frame being outside of said chambers.

2. (canceled)

3: The engine of claim 1, wherein:
said shuttle frame is external of, and spaced from, each of said chambers; and
said shuttle centerline is linear.

4. (canceled)

5: The engine of claim 3, wherein:
said first shuttle part is generally cylindrical, having a first piston end providing said first shuttle surface and a second piston end providing said second shuttle surface;
said second shuttle part is generally cylindrical, having a third piston end providing said third shuttle surface and a fourth piston end providing said fourth shuttle surface;
said first and second shuttle parts are axially aligned and spaced along said shuttle centerline; and
said engine block structure includes a generally cylindrical first cavity housing said first piston end, a generally cylindrical second cavity housing said second piston end, a generally cylindrical third cavity housing said third piston ends and a generally cylindrical fourth cavity housing said fourth piston end and wherein:
said first chamber is generally cylindrical and bounded by said first cavity and said first shuttle surface;
said second chamber is generally cylindrical and bounded by said second cavity Q and said second shuttle surface;
said third chamber is generally cylindrical and bounded by said third cavity and said third shuttle surface; and
said fourth chamber is generally cylindrical and bounded by said fourth cavity and said fourth shuttle surface.

6: The engine of claim 5, wherein said shuttle frame comprises at least one rod assembly having a rod extending parallel to said shuttle centerline, a first radial strut joining said rod to said first shuttle parts and a second radial strut joining said rod to said second shuttle part.

7: The engine of claim 6, wherein said rod is radially spaced from said four chambers.

8: The engine of claim 6, wherein said shuttle frame comprises four of said rod assemblies equally spaced from said shuttle centerline and from each other.

9. (canceled)

10: The engine of claim 3, wherein:
said first shuttle part is generally cylindrical, having a first piston end providing said first shuttle surface and a second piston end providing said second shuttle surface;
said second shuttle part is generally annular prismatic with a greater inside diameter than an outside diameter of said first shuttle part, said second shuttle part having a third piston end providing said third shuttle surface and a fourth piston end providing said fourth shuttle surface;
said first and second shuttle parts are coaxial along said shuttle centerline, said second shuttle part being axially arranged around said first shuttle part; and
said engine block structure includes a generally cylindrical first cavity housing said first piston end, a generally cylindrical second cavity housing said second piston end, a generally annular prismatic third cavity housing said third piston end, and a generally annular prismatic fourth cavity housing said fourth piston end and wherein:
said first chamber is generally cylindrical and bounded by said first cavity and said first shuttle surface;
said second chamber is generally cylindrical and bounded by said second cavity and said second shuttle surface;
said third chamber is generally annular prismatic and bounded by said third cavity and said third shuttle surface; and
said fourth chamber is generally annular prismatic and bounded by said fourth cavity and said fourth shuttle surface.

11: The engine of claim 10, wherein said shuttle frame comprises at least one radial strut joining said first shuttle part to said second shuttle part.

12: The engine of claim 10, wherein said shuttle frame comprises an annular plate joining said first shuttle part to said second shuttle part.

13: The engine of claim 11, wherein said shuttle frame comprises a plurality of spaced radial struts.

14-16. (canceled)

17. (canceled)

18: The engine of claim 1, wherein:
said shuttle frame is peripheral to, and forms a boundary of, each of said chambers; and
said shuttle centerline is linear.

19. (canceled)

20: The engine of claim 18, wherein:
said shuttle frame is generally tubular, having an axis along said shuttle centerline and defining a generally cylindrical space within said shuttle frame;
said first shuttle part is generally cylindrical and is located within said cylindrical space, dividing said cylindrical space into a first shuttle end cavity and a shuttle middle cavity;
said second shuttle part is generally cylindrical and is located within said cylindrical space, axially spaced from said first shuttle part and further dividing said cylindrical space into said shuttle middle cavity and a second shuttle end cavity; and
said engine block structure includes:
an inner block portion located within said shuttle middle cavity, said inner block portion having a generally circular first end face and an opposite generally circular second end face;
a first outer block portion extending into said first shuttle end cavity, said first outer block portion having a generally circular end face opposing said first end face of said inner block portion; and
a second outer block portion extending into said second shuttle end cavity, said second outer block portion having a generally circular end face opposing said second end face of said inner block portion, wherein:
said first chamber is bounded by said shuttle frame, said end face of said first outer block portion, and said first shuttle surface;
said second chamber is bounded by said shuttle frame, said first end face of said inner block portion, and said second shuttle surface;
said third chamber is bounded by said shuttle frame, said second end face of said inner block portion, and said third shuttle surface; and
said fourth chamber is bounded by said shuttle frame, said end face of said first outer block portion, and said fourth shuttle surface.

21: The engine of claim 20, wherein said shuttle middle cavity includes at least one aperture through which said inner block portion is supported.

22. (canceled)

23: The engine of claim 18, wherein:
said shuttle frame has a generally tubular inner frame wall and a generally tubular outer frame wall having a greater inner diameter than an outer diameter of said inner frame wall, said outer and inner frame walls being coaxial about said shuttle centerline, a generally cylindrical inner space being defined within said inner frame wall and a generally annular prismatic outer space being defined between said outer frame wall and said inner frame wall;
said first shuttle part is generally cylindrical and located in said inner space, dividing said inner space into first and second shuttle inner cavities;
said second shuttle part is generally annular prismatic and located in said outer space, dividing said outer space into first and second shuttle outer cavities; and
said engine block structure includes:
a first inner block portion extending into said first shuttle inner cavity, said first inner block portion having a generally circular end face; and
a second inner block portion extending into said second shuttle inner cavity, said second inner block portion having a generally circular end face opposing said end face of said first inner block portion;
a first outer block portion extending into said first shuttle outer cavity, said first outer block portion having a generally annular end face;
a second outer block portion extending into said second shuttle outer cavity, said second outer block portion having a generally annular end face opposing said end face of said first outer block portion, wherein:
said first chamber is bounded by said inner frame wall, said end face of said first inner block portion and said first shuttle surface;
said second chamber is bounded by said inner frame wall, said end face of said second inner block portion and said second shuttle surface;
said third chamber is bounded by said outer frame wall, said inner frame wall, said end face of said first outer block portion and said third shuttle surface; and
said fourth chamber is bounded by said outer frame wall, said inner frame wall, said end face of said second outer block portion and said fourth shuttle surface.

24-27. (canceled)

28: The engine of claim 1, wherein said first and second shuttle surfaces are congruent and said third and fourth shuttle surfaces are also congruent.

29: The engine of claim 1, wherein said engine includes a power extraction device adapted to convert said reciprocation of said shuttle into a power output source.

30-31. (canceled)

32: The engine of claim 29, wherein said power extraction device includes at least one induction coil forming part of one of said shuttle and said engine block structure and at least one magnet forming part of the other of said shuttle and said engine block structure.

33: The engine of claim 1, wherein communication between each chamber and a respective fluid passage is controlled by a valve arranged between each chamber and the respective fluid passage.

34: The engine of claim 1, wherein at least one of said fluid passages communicates with two or more of said chambers.

35: The engine of claim 1, further comprising an homogeneous charge compression ignition system.

36. (canceled)

37: The engine of claim 29, further comprising:
a feedback controller adapted to control the amount of energy extracted per stroke by said power extraction device; and
a sensor adapted to determine a speed of said shuttle, said feedback controller being adapted to extract more or less kinetic energy per stroke depending on whether said shuttle speed is above or below a set optimum speed.

38: The engine of claim 1, further comprising a supercharger adapted to minimize heat loss.

39: The engine of claim 38, wherein said shuttle further comprises a third shuttle part with fifth and sixth opposite shuttle surfaces, said shuttle frame connecting all three shuttle parts, wherein said supercharger comprises:
a fifth chamber formed between said fifth shuttle surface and said engine block structure, said fifth chamber being in selective fluid communication with said outlet fluid passages and an exhaust manifold; and
a sixth chamber formed between said sixth shuttle surface and said engine block structure, said sixth chamber being in selective fluid communication with said inlet fluid passages and an intake manifold.

40: The engine of claim 1, wherein said, shuttle is exposed to ambient air.

41: The engine of claim 1, wherein said shuttle parts are hollow.
